(19) United States
(12) Patent Application Publication
(10) Pub. No.: US 2014/0295839 A1
(43) Pub. Date: Oct. 2, 2014

(54) HYPER-CELLULAR COMMUNICATION SYSTEM

(71) Applicant: HITACHI, LTD., Tokyo (JP)

(72) Inventors: Jian WU, Beijing (CN); Peng YANG, Beijing (CN); Yanan BAO, Beijing (CN); Chunguang LIU, Beijing (CN); Sheng ZHOU, Beijing (CN); Zhisheng NIU, Beijing (CN); Mika MIZUTANI, Beijing (CN)

(73) Assignee: HITACHI, LTD., TOKYO (JP)

(21) Appl. No.: 14/204,096

(22) Filed: Mar. 11, 2014

(30) Foreign Application Priority Data
Mar. 29, 2013 (CN) 201310106539.0

(51) Int. Cl. H04W 76/02; H04W 28/02

(52) U.S. Cl. CPC H04W 76/021; H04W 28/0268
USPC 455/435.3

(57) ABSTRACT

Provided are a hyper-cellular communication system and a hyper-cellular communication method for associating a user to a macro cell base station or a micro cell base station. The hyper-cellular communication system includes: a gateway, which includes a user quality of service classification index table including two parameters, namely user mobility and signaling overhead; and a resource optimization function unit for making decisions on base station association and wireless resource allocation by referring to the quality of service classification index table.

### CLAIM OF PRIORITY

The present application claims priority from Chinese patent application No. 201310106539.0 filed on Mar. 29, 2013, the content of which is hereby incorporated by reference into this application.

### BACKGROUND

This invention relates to a hyper-cellular communication system. Diversified services involved in smart phone and machine-to-machine (M2M) applications have greatly affected the current mobile cellular network. In particular, the proportion of the medium-to-small traffic (background services of instant messages and M2M services) in the current network is increasing gradually, and signaling overheads produced thereby occupy even more than 60% resources at the air interfaces. Here, the concept of the hyper-cell is adopted to simplify signaling and to improve throughput. At present, comprehensive studies have not been made on the mechanism of optimizing the use of system resources by using a scheduling design of diversified services in the mobile cellular network.

NTT Docomo has proposed the concept of phantom cell in 3rd generation partnership project (3GPP) RAN. The researchers have considered the separation and optimization scenarios of control plane and user plane, in which different cells had different signaling configurations. However, the effect brought by diversified services and the corresponding solutions have not been considered.

Further, 3GPP RAN work group has already started the study on small cell enhancement, and the architecture of the hyper-cell has been proposed. Uneven distribution of services among different cells has also been considered. However, the types of diversified services have not been considered. Therefore, this patent application is very necessary also for the study on small cell enhancement.

Moreover, 3GPP has already set the definition for quality of service (QoS) and the standard for Policy and Charging Control (PCC). However, the load of the air interface produced by small data packets has not been considered in the QCI table. In other words, the existing PCC mechanism cannot resolve the problem of massive signaling overhead produced by small data packets in the network.

Lastly, International Patent W02011/143824A has proposed a scheduling mechanism for optimizing QoS within the orthogonal frequency division multiple access (OFDMA) system, and has mainly researched the types of services of different applications and the allocation of resource blocks at the air interface. However, the research is limited to point-to-point link transmissions. Signaling overhead produced by different types of services has not been considered.

### SUMMARY

In the architecture of the heterogeneous cellular network, in consideration of the coexistence of various types of services, especially small traffics, the inventors of this invention have studied the selection of base station and resource allocation for different users in this case. The object of this invention is to provide a hyper-cellular communication system and a hyper-cellular communication method for improving base station association and resource allocation of differentiated services.

According to one embodiment of this invention, there is provided a hyper-cellular communication system for associating a user to one of a macro cell base station and a micro cell base station, the hyper-cellular communication system including: a gateway, including a user quality of service classification index table including two parameters, namely user mobility and signaling overhead; and a resource optimization function unit for making decisions on base station association and wireless resource allocation by referring to the quality of service classification index table.

The hyper-cellular communication system according to one embodiment of this invention can reduce frequent switches of the high mobility user among micro cells and thereby balance the signaling traffics in macro cells and micro cells.

### BRIEF DESCRIPTION OF THE DRAWINGS

FIG. 1 is a diagram illustrating the topology of the hyper-cell.

FIG. 2 is a diagram illustrating one method of measuring user mobility.

FIG. 3 is a diagram illustrating the other method of measuring user mobility.

FIG. 4 is a diagram illustrating the system architecture of the hyper-cellular communication system.

FIG. 5 shows an example of a quality of service classification index table QCI after adding two parameters, namely user mobility and signaling overhead.

FIG. 6 is a structure diagram schematically illustrating a resource optimization function unit ROF.

FIG. 7 is a structure diagram schematically illustrating a policy and charging rules function unit PCRF.

FIG. 8 is a structure diagram schematically illustrating a module of a gateway GW.

FIG. 9 is a flowchart used for the resource optimization function unit ROF to provide the selection service of associating base stations.

FIG. 10 is a typical signaling interaction diagram of the hyper-cellular communication system of this invention.

### DETAILED DESCRIPTION OF THE EMBODIMENTS

One embodiment provides a hyper-cellular communication system for associating a user to one of a macro cell base station and a micro cell base station. The hyper-cellular communication system includes: a gateway, including a user quality of service classification index table including two parameters, namely user mobility and signaling overhead; and a resource optimization function unit for making decisions on base station association and wireless resource allocation by referring to the quality of service classification index table.

Further, in the hyper-cellular communication system according to one embodiment, the resource optimization function unit may include: an inquiry part for inquiring the user mobility in the quality of service classification index table; and a decision-making part for selecting and modulating a mode of associating the user and allocating data resources and signaling resources based on a query result of the inquiry part.

Further, in the hyper-cellular communication system according to one embodiment, the decision-making part may couple the user to a macro cell when the query result of the inquiry part indicates that the user mobility is higher than a first threshold value; and the decision-making part may couple the user to a micro cell when the query result of the inquiry part indicates that the user mobility is lower than the first threshold value.

Further, in the hyper-cellular communication system according to one embodiment, when the signaling overhead in the macro cell is higher than a second threshold value, the inquiry part may inquire the signaling overhead of the user's service in the quality of service classification index table and determine whether the signaling overhead of the user's service is higher than a third threshold value or not, and the decision-making part may couple the user to the micro cell when it is determined that the signaling overhead of the user's service is higher than the third threshold value.

Further, the hyper-cellular communication system according to one embodiment may further include a policy and charging rules function unit, and the policy and charging rules function unit may include: a measuring part for measuring the user mobility and the signaling overhead of the user's service; and a requesting part for requesting the gateway to update the quality of service classification index table based on a measurement result of the measuring part.

Further, in the hyper-cellular communication system according to one embodiment, the measuring part may measure a switching frequency of the user among micro cells per unit time; and the measuring part may determine that the user is a high mobility user when a result of the switching frequency is higher than a fourth threshold value, and determine that the user is a low mobility user when the result of the switching frequency is lower than the fourth threshold value.

Further, in the hyper-cellular communication system according to one embodiments, the measuring part may measure a frequency of changes in signal strength per unit time; and the measuring part may determine that the user is a high mobility user when the frequency of changes in signal strength per unit time is higher than a fifth threshold value, and determine that the user is a low mobility user when the frequency of changes in signal strength per unit time is lower than the fifth threshold value.

According to one embodiment, there is provided a hyper-cellular communication method for associating a user to one of a macro cell base station and a micro cell base station, including: inquiring user mobility in a quality of service classification index table including two parameters, namely user mobility and signaling overhead; and selecting and modulating a mode of associating the user and allocating data resources and signaling resources based on a query result of the inquiring.

Further, the hyper-cellular communication method according to one embodiment may further include: coupling the user to a macro cell when the query result indicates that the user mobility is higher than a first threshold value; and coupling the user to a micro cell when the query result indicates that the user mobility is lower than the first threshold value.

Further, the hyper-cellular communication method according to one embodiment may further include: inquiring the signaling overhead of the user's service in the quality of service classification index table when the signaling overhead in the macro cell is higher than a second threshold value; and determining whether the signaling overhead of the user's service is higher than a third threshold value or not, and then coupling the user to a micro cell when it is determined that the signaling overhead of the user's service is higher than the third threshold value.

Further, the hyper-cellular communication method according to one embodiment may further include: measuring the user mobility and the signaling overhead of the user's service; and requesting the gateway to update the quality of service classification index table based on a result of the measuring.

Further, in the hyper-cellular communication method according to one embodiment, the measuring may include: measuring a switching frequency of the user among micro cells per unit time; and determining that the user is a high mobility user when a result of the switching frequency is higher than a fourth threshold value, and determining that the user is a low mobility user when the result of the switching frequency is lower than the fourth threshold value.

Further, in the hyper-cellular communication method according to one embodiment, the measuring may include: measuring a frequency of changes in signal strength per unit time; and determining that the user is a high mobility user when the frequency of changes in signal strength per unit time is higher than a fifth threshold value, and determining that the user is a low mobility user when the frequency of changes in signal strength per unit time is lower than the fifth threshold value.

The hyper-cellular communication system according to one embodiment can reduce frequent switches of the high mobility user among micro cells and thereby balance the signaling traffics in macro cells and micro cells. Moreover, the hyper-cellular communication system according to one embodiment optimizes the resources in the mobile cellular network for “actual” various user data services, and the operating time (including battery consumption) of the user terminal is not influenced. The novel architecture proposed in this invention is in good compatibility with the current network system, in other words, the novel architecture proposed can be supported without bulk update of network equipment.

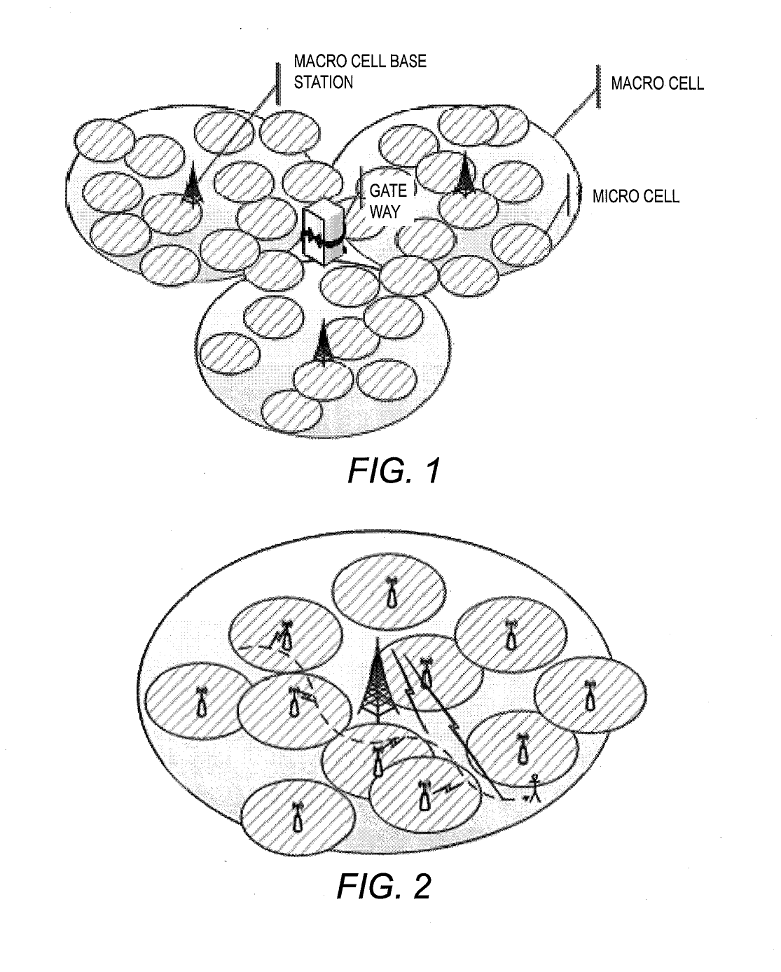

Hereinafter, the present inventions are described in detail with reference to the drawings. FIG. 1 is a diagram illustrating the topology of the hyper-cell. The macro cells and the micro cells form an overlapping coverage area within the hyper-cellular communication system. The coverage area of the macro cells is much larger than that of the micro cells. However, the resource consumption of the macro cells is also obviously higher than that of the micro cells.

The wireless resources within both the macro cells and the micro cells are able to be allocated to data traffics and signaling traffics. However, because the total bandwidth is limited, the allocation ratio needs to be optimized. In this case, considerations need to be made for service delay, service optimum rate, channel status and interference level in the well-known art, as well as signaling overhead of service and mobility of users requesting for service.

In evaluating the selection of access threshold based on user mobility, it is necessary to select the suitable parameters through the optimization of the system.

Similarly, in evaluating signaling overhead of the macro cell, it is necessary to optimize the design of the specific load transfer threshold depending on the actual system parameters.

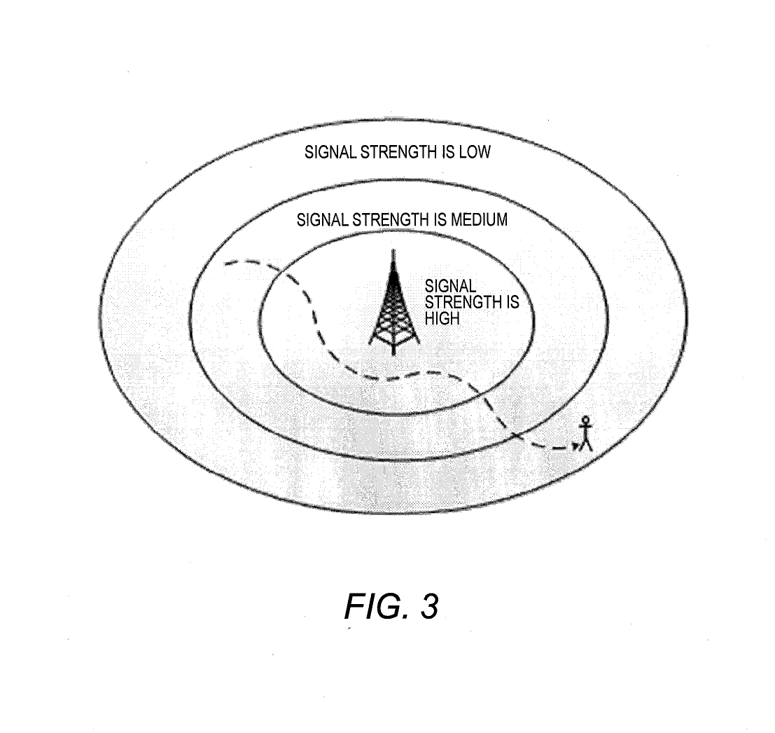

It is easy to estimate the signaling overhead of a service, but some special measuring methods need to be considered for mobility of a user. FIG. 2 and FIG. 3 illustrate separate two methods of measuring the mobility of one user.

FIG. 2 is a diagram illustrating one method of measuring user mobility. The ID of a user to be associated with each micro cell, which varies with time, is recorded. The switching frequency of the user among micro cells per unit time is calculated. The user is determined as a high mobility user when the result of the switching frequency is higher than a given threshold value, and the user is determined as a low mobility user when the result of the switching frequency is lower than the given threshold value. Measurement of the mobility is carried out by a measuring part 21 of a policy and charging rules function unit PCRF as described later, and the detailed contents are described later.

FIG. 3 is a diagram illustrating the other method of measuring user mobility. The changes in the strength of the signal received from the macro cell base stations by the user are recorded. A higher frequency of changes in signal strength per unit time with a larger change indicates higher user mobility. The user is determined as a high mobility user when the frequency of changes in signal strength per unit time is higher than a given threshold value, and the user is determined as a low mobility user when the frequency of changes in signal strength per unit time is lower than the given threshold value. Measurement of the mobility is carried out by the measuring part 21 of the policy and charging rules function unit PCRF as described later, and the detailed contents are described later.

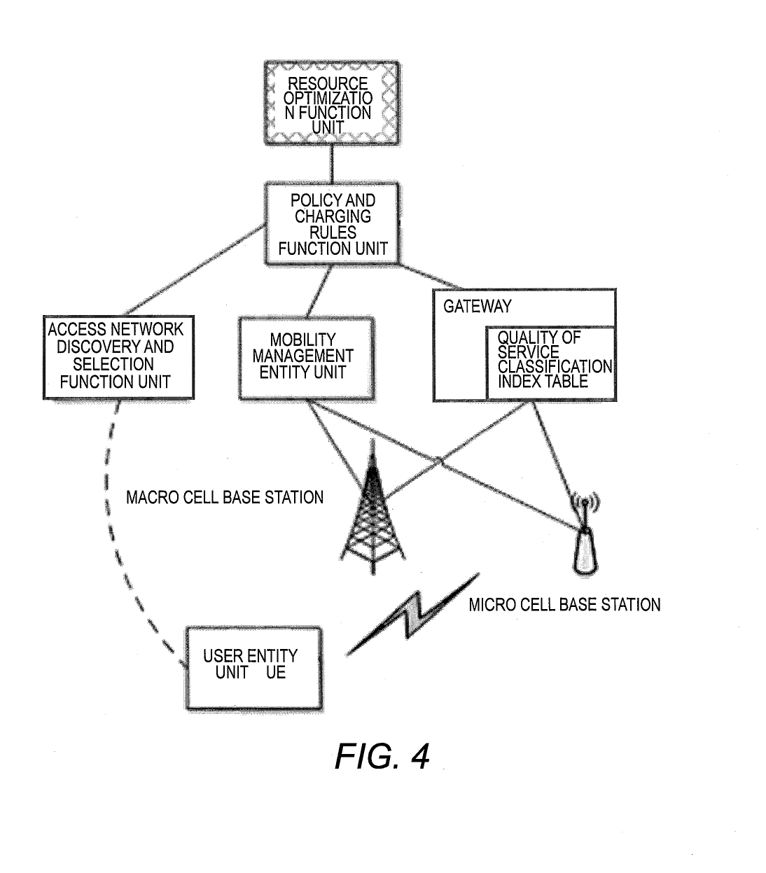

FIG. 4 is a diagram illustrating the system architecture of the hyper-cellular communication system. The hyper-cellular communication system includes a resource optimization function unit ROF, a policy and charging rules function unit PCRF, an access network discovery and selection function unit ANDSF, a mobility management entity unit MME, a gateway GW, a user entity unit UE, a macro cell base station, and a micro cell base station. The gateway GW is provided with a quality of service (QoS) classification index table QCI. These units may be configured by processors operable according to programs and/or dedicated hardware circuits.

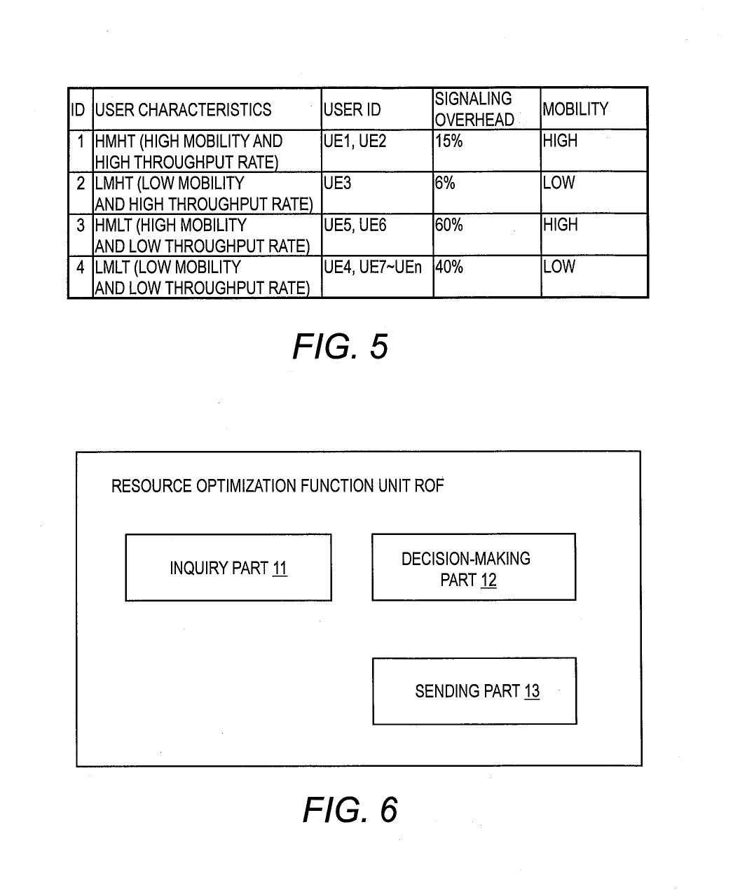

FIG. 5 shows an example of the quality of service classification index table QCI after adding two parameters, namely user mobility and signaling overhead.

FIG. 5 exemplifies four types of users, respectively being high mobility and high throughput rate (HMHT), low mobility and high throughput rate (LMHT), high mobility and low throughput rate (HMLT), low mobility and low throughput rate (LMLT). Here, high throughput rate represents low signaling overhead, and low throughput rate represents high signaling overhead. The user with high mobility and high throughput rate (HMHT), for example, is UE1, UE2, for which the signaling overhead is 15% as an example and the mobility is high. The user with low mobility and high throughput rate (LMHT), for example, is UE3, for which the signaling overhead is 6% as an example and the mobility is low. The user with high mobility and low throughput rate (HMLT), for example, is UE5, UE6, for which the signaling overhead is 60% as an example and the mobility is high. The user with low mobility and low throughput rate (LMLT), for example, is UE4, UE7 to UEn, for which the signaling overhead is 40% as an example and the mobility is low.

FIG. 6 is a structure diagram schematically illustrating the resource optimization function unit ROF. The resource optimization function unit mainly has the function of making decisions on base station association and wireless resource allocation, and also has the functions of inquiring system status and sending result of decisions. The resource optimization function unit ROF includes an inquiry part 11, a decision-making part 12, and a sending part 13. The inquiry part 11 is used for inquiring the QCI information of the user, current system traffic, channel status, and interference level. The decision-making part 12 is used for selecting and modulating the mode of associating the user and for allocating data resources and signaling resources. The sending part 13 is used for sending the result of decisions to the policy and charging rules function unit PCRF. These parts may be configured by processors operable according to programs and/or dedicated hardware circuits.

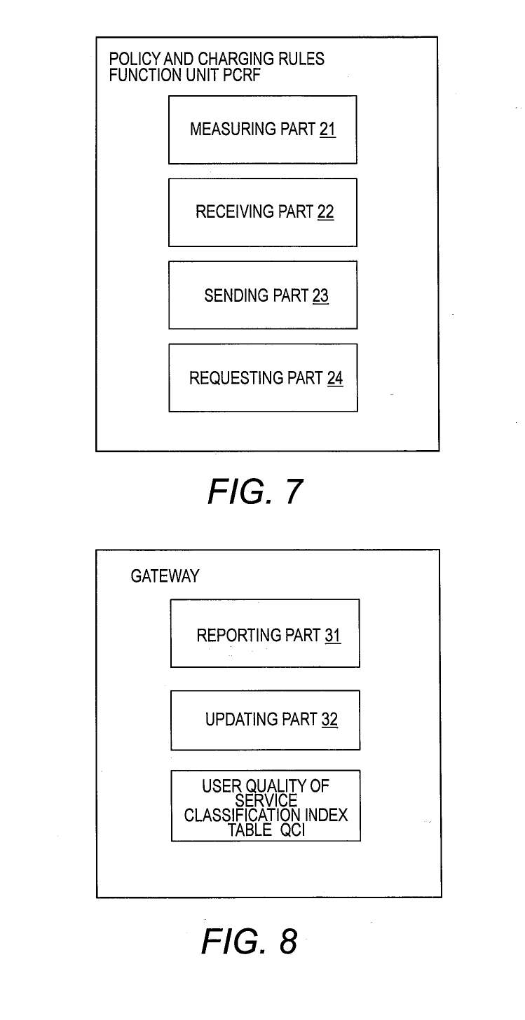

FIG. 7 is a structure diagram schematically illustrating the policy and charging rules function unit PCRF. Besides the functions in the well-known art, the policy and charging rules function unit PCRF is further in charge of measuring user mobility and signaling overhead of service. Further, as the core of the network, the policy and charging rules function unit PCRF is the functional entity for producing and transmitting a large number of signals and data.

The policy and charging rules function unit PCRF includes a measuring part 21, a receiving part 22, a sending part 23 and a requesting part 24. These parts may be configured by processors operable according to programs and/or dedicated hardware circuits.

The measuring part 21 is used for measuring user mobility and signaling overhead of service. The measuring part 21 has two measuring methods illustrated in FIG. 2 and FIG. 3.

According to the measuring method as illustrated in FIG. 2, the measuring part 21 records the ID of a user to be associated with each micro cell, which varies with time, and calculates the switching frequency of the user among micro cells per unit time. The measuring part 21 determines that the user is a high mobility user when the result of the switching frequency is higher than a given threshold value, and determines that the user is a low mobility user when the result of the switching frequency is lower than the given threshold value.

According to the measuring method as illustrated in FIG. 3, the measuring part 21 records changes in the strength of the signals received from the macro cell base stations by the user. A higher frequency of changes in signal strength per unit time with a larger change indicates higher user mobility. The user is determined as a high mobility user when the frequency of changes in signal strength per unit time is higher than a given threshold value, and the user is determined as a low mobility user when the frequency of changes in signal strength per unit time is lower than the given threshold value.

The receiving part 22 is used for receiving the result of the decision sent by the sending part of the resource optimization function unit ROF.

The sending part 23 is used for sending the result of down-link decision to the mobile management entity unit MME, sending the result of up-link decision to the access network discovery and selection function unit ANDSF, and sending the result of up-link decision to the user entity unit UE.

The requesting part 24 requests the gateway GW to update the user quality of service classification index table QCI based on the measuring result of the measuring part 21.

FIG. 8 is a structure diagram schematically illustrating the gateway GW. The gateway GW includes a reporting part 31, an updating part 32, and a user quality of service classification index table QCI. These parts may be configured by processors operable according to programs and/or dedicated hardware circuits. The reporting part 31 is used for reporting the user quality of service classification index table QCI to the resource optimization function unit ROF.

The updating part 32 is used for updating the user quality of service classification index table QCI.

Two parameters are added to the user quality of service classification index table QCI, namely user mobility and signaling overhead of service.

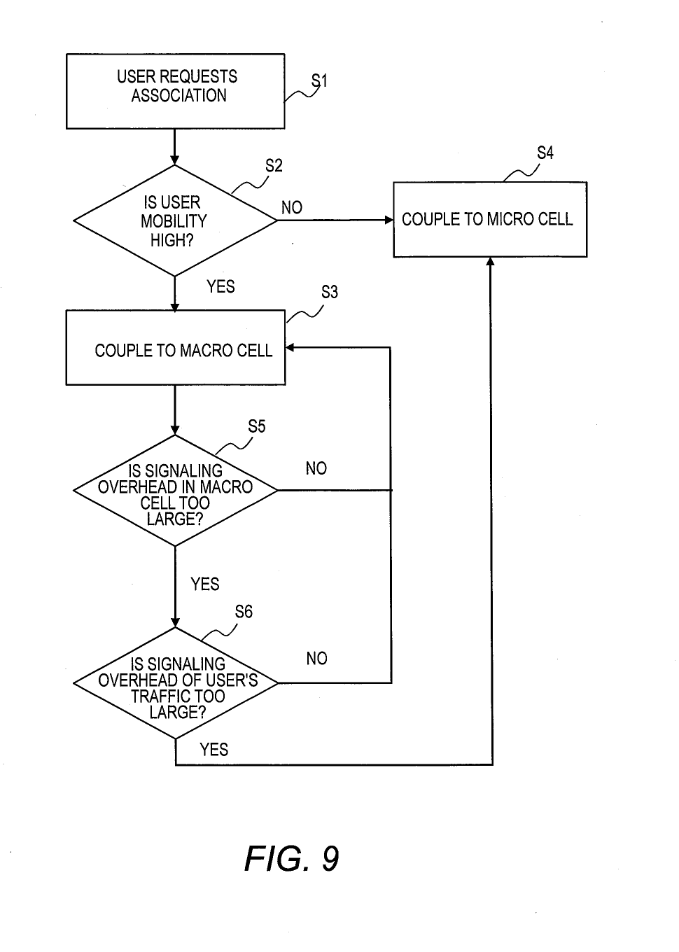

FIG. 9 is a flowchart used for the resource optimization function unit ROF to provide the selection service of associating the base stations.

In Step S1, the user requests the policy and charging rules function unit PCRF for base station association. In Step S2, the inquiry part of the resource optimization function unit ROF inquires the user mobility in the user quality of service classification index table QCI and determines whether the user mobility is high or not. When it is determined that the user mobility is high, the flow proceeds to Step S3, in which the decision-making part of the resource optimization function unit ROF couples the user to a macro cell. On the other hand, when it is determined in Step S2 that the user mobility is low, the flow proceeds to Step S4, in which the decision-making part of the resource optimization function unit ROF couples the user to a micro cell. In this way, frequent switches of a high mobility user among micro cells can be reduced.

Further, after proceeding to Step S3 of coupling the user to a macro cell, the flow proceeds to Step S5, in which it is determined whether the signaling overhead in the macro cell is too large or not, in other words, exceeds a given threshold value or not. When it is determined that the signaling overhead in the macro cell is too large, in other words, exceeds a given threshold value, the flow proceeds to Step S6, in which the inquiry part of the resource optimization function unit ROF inquires the signaling overhead of the user's service in the user quality of service classification index table QCI, and determines whether the signaling overhead of the user's service is too large or not, in other words, exceeds a given threshold value or not. When it is determined that the signaling overhead of the user's service is too large, in other words, exceeds a given threshold value, the flow proceeds to Step S4, in which the decision-making part of the resource optimization function unit ROF couples the user to a micro cell.

In this way, the signaling traffics in macro cells and micro cells can be balanced.

On the other hand, when it is determined in Step S5 that the signaling overhead in the macro cell is not too large, in other words, lower than a given threshold value, the flow returns to Step S3 and repeats the determination of Step S5. When it is determined in Step S6 that the signaling overhead of the user's service is not too large, in other words, lower than a given threshold value, the flow returns to Step S3 and repeats the determination of Step S6.

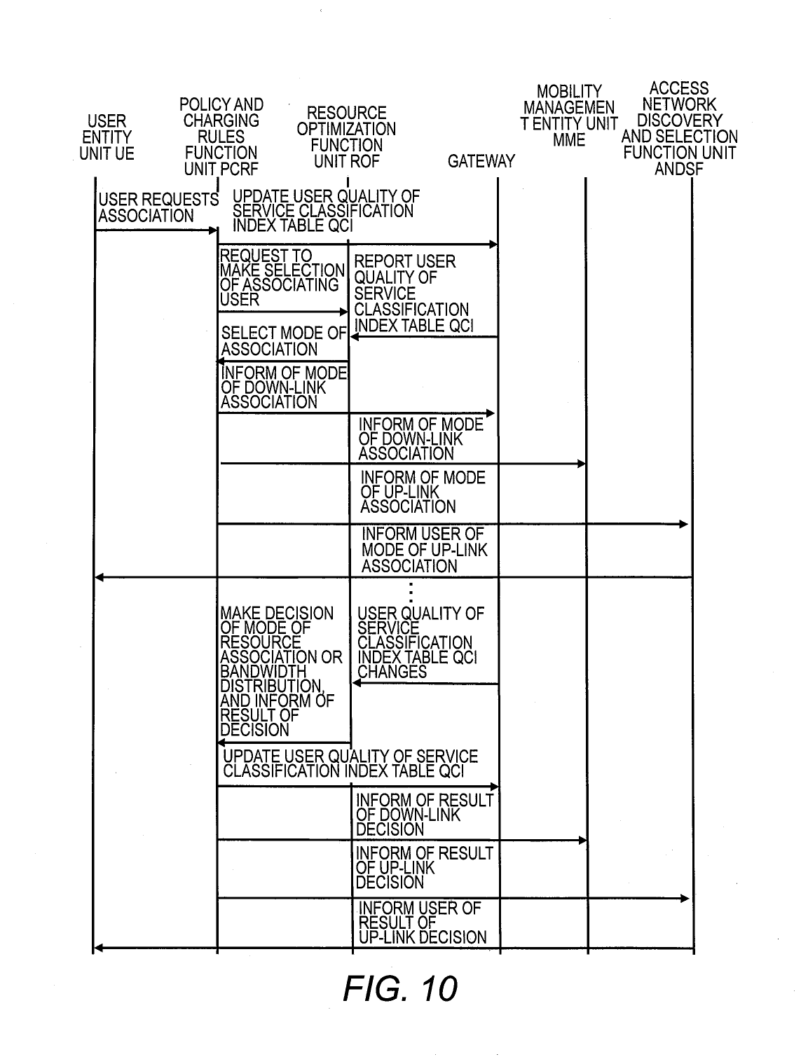

FIG. 10 is a typical signaling interaction diagram of the hyper-cellular communication system. Here, the ROF carries out the user association and the resource allocation, and the other modules are in charge of reporting the status to the ROF and transmitting the result of decision of the ROF.

The user entity unit UE requests the policy and charging rules function unit PCRF for base station association. The policy and charging rules function unit PCRF requests the gateway GW to update the user quality of service classification index table QCI. The policy and charging rules function unit PCRF requests the resource optimization function unit ROF for selection of associating the user. The gateway GW reports the user quality of service classification index table QCI to the resource optimization function unit ROF. The resource optimization function unit ROF selects the mode of associating the user. The policy and charging rules function unit PCRF informs the gateway GW and the mobile management entity unit MME of the result of down-link decision and sends the result of up-link decision to the access network discovery and selection function unit ANDSF. The access network discovery and selection function unit ANDSF informs the user entity unit UE of the mode of up-link association.

When the user quality of service classification index table QCI changes, for example, when the user mobility changes, the resource optimization function unit ROF makes decisions on the mode of the resource association and the band width distribution, and informs the policy and charging rules function unit PCRF of the result of decisions.

The policy and charging rules function unit PCRF requests the gateway GW to update the user quality of service classification index table QCI. The policy and charging rules function unit PCRF informs the mobile management entity unit MME of the result of down-link decision, and informs the access network discovery and selection function unit ANDSF of the result of up-link decision. The access network discovery and selection function unit ANDSF informs the user entity unit UE of the result of up-link decision.

The invention is not limited to the above-described embodiments but includes various modifications. The above-described embodiments are explained in details for better understanding and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

What is claimed is:

1. A hyper-cellular communication system for associating a user to one of a macro cell base station and a micro cell base station, the hyper-cellular communication system comprising:
a gateway comprising a user quality of service classification index table including two parameters, namely user mobility and signaling overhead; and
a resource optimization function unit for making decisions on base station association and wireless resource allocation by referring to the quality of service classification index table.

2. The hyper-cellular communication system according to claim 1, wherein the resource optimization function unit comprises:
an inquiry part for inquiring the user mobility in the quality of service classification index table; and
a decision-making part for selecting and modulating a mode of associating the user and allocating data resources and signaling resources based on a query result of the inquiry part.

3. The hyper-cellular communication system according to claim 2, wherein:
the decision-making part couples the user to a macro cell when the query result of the inquiry part indicates that the user mobility is higher than a first threshold value; and
the decision-making part couples the user to a micro cell when the query result of the inquiry part indicates that the user mobility is lower than the first threshold value.

4. The hyper-cellular communication system according to claim 3, wherein:
when the signaling overhead in the macro cell is higher than a second threshold value, the inquiry part inquires the signaling overhead of the user's service in the quality of service classification index table and determines whether the signaling overhead of the user's service is higher than a third threshold value or not; and
the decision-making part couples the user to the micro cell when it is determined that the signaling overhead of the user's service is higher than the third threshold value.

5. The hyper-cellular communication system according to claim 1, further comprising a policy and charging rules function unit,
wherein the policy and charging rules function unit comprises:
a measuring part for measuring the user mobility and the signaling overhead of the user's service; and
a requesting part for requesting the gateway to update the quality of service classification index table based on a measurement result of the measuring part.

6. The hyper-cellular communication system according to claim 5, wherein:
the measuring part measures a switching frequency of the user among micro cells per unit time; and
the measuring part determines that the user is a high mobility user when a result of the switching frequency is higher than a fourth threshold value, and determines that the user is a low mobility user when the result of the switching frequency is lower than the fourth threshold value.

7. The hyper-cellular communication system according to claim 5, wherein:
the measuring part measures a frequency of changes in signal strength per unit time; and
the measuring part determines that the user is a high mobility user when the frequency of changes in signal strength per unit time is higher than a fifth threshold value, and determines that the user is a low mobility user when the frequency of changes in signal strength per unit time is lower than the fifth threshold value.

8. A hyper-cellular communication method for associating a user to one of a macro cell base station and a micro cell base station, comprising:
inquiring user mobility in a quality of service classification index table including two parameters, namely user mobility and signaling overhead; and
selecting and modulating a mode of associating the user and allocating data resources and signaling resources based on a query result of the inquiring.

9. The hyper-cellular communication method according to claim 8, further comprising:
coupling the user to a macro cell when the query result indicates that the user mobility is higher than a first threshold value; and
coupling the user to a micro cell when the query result indicates that the user mobility is lower than the first threshold value.

10. The hyper-cellular communication method according to claim 9, further comprising:
inquiring the signaling overhead of the user's service in the quality of service classification index table when the signaling overhead in the macro cell is higher than a second threshold value; and
determining whether the signaling overhead of the user's service is higher than a third threshold value or not, and then coupling the user to a micro cell when it is determined that the signaling overhead of the user's service is higher than the third threshold value.

11. The hyper-cellular communication method according to claim 8, further comprising:
measuring the user mobility and the signaling overhead of the user's service; and
requesting the gateway to update the quality of service classification index table based on a result of the measuring.

12. The hyper-cellular communication method according to claim 11, wherein the measuring comprises:
measuring a switching frequency of the user among micro cells per unit time; and
determining that the user is a high mobility user when a result of the switching frequency is higher than a fourth threshold value, and determining that the user is a low mobility user when the result of the switching frequency is lower than the fourth threshold value.

13. The hyper-cellular communication method according to claim 11, wherein the measuring comprises:
measuring a frequency of changes in signal strength per unit time; and
determining that the user is a high mobility user when the frequency of changes in signal strength per unit time is higher than a fifth threshold value, and determining that the user is a low mobility user when the frequency of changes in signal strength per unit time is lower than the fifth threshold value.
